(19) United States
(12) Patent Application Publication
(10) Pub. No.: US 2025/0389612 A1
(43) Pub. Date: Dec. 25, 2025

(54) COMPOSITE JOINT INSPECTION

(71) Applicant: The Boeing Company, Arlington, VA (US)

(72) Inventor: Nayeem Tawqir Chowdhury, Melbourne (AU)

(21) Appl. No.: 18/750,630

(22) Filed: Jun. 21, 2024

(51) Int. Cl. G01M 5/00; B64F 5/60

(52) U.S. Cl. CPC G01M 5/0091; B64F 5/60; G01M 5/0041; G01M 5/0016

(57) ABSTRACT

A composite joint inspection system and methods of use and forming are presented. A composite joint inspection system comprises a cavity formed by at least two composite components; a composite filler within the cavity; and a fiber optic cable running through the cavity extending out from at least one of a first end of the cavity or a second end of the cavity. The fiber optic cable is in contact with the composite filler.

### BACKGROUND INFORMATION

### 1. Field

The present disclosure relates generally to non-destructive inspection and more specifically to inspection of composite joints.

### 2. Background

Composite structures may be fabricated by joining two or more members together. In some cases, there may be one or more gaps in areas of joints between the members that may reduce the strength of the joints. In order to strengthen the joints, the gaps are filled with fillers, sometimes also referred to as radius fillers, composite fillers, fillets, or noodles.

Some composite airframe components, such as skin-stringer and web-flange attachment of beams and channels, comprise these structural elements which are referred as “noodles”. Noodles or radius fillers are used to fill-out the radius bend of curved composite laminate structures. Noodles are constructed from composites with orientations different from the primary laminated structure. Noodles are located in areas that might be undesirably difficult or inconsistent to inspect by typical nondestructive methods. Typical nondestructive inspection using ultrasonic waves is costly, time consuming and inconsistent for inspection of curvatures and noodles due to complex geometry and location.

Therefore, it would be desirable to have a method and apparatus that takes into account at least some of the issues discussed above, as well as other possible issues. It would be desirable to develop a technique for nondestructively inspecting a noodle area inside a curved composite laminate structure.

### SUMMARY

An embodiment of the present disclosure provides a composite joint inspection system. The composite joint inspection system comprises a cavity formed by at least two composite components; a composite filler within the cavity; and a fiber optic cable running through the cavity extending out from at least one of a first end of the cavity or a second end of the cavity, the fiber optic cable in contact with the composite filler.

An embodiment of the present disclosure provides an aircraft. The aircraft comprises a composite joint with an integrated strain detector. The integrated strain detector comprises a first composite component; a second composite component; a composite filler positioned in a cavity between the first composite component and the second composite component; and a fiber optic cable running through the cavity extending out from at least one of a first end of the cavity or a second end of the cavity, the fiber optic cable in contact with the composite filler.

An embodiment of the present disclosure provides a method of inspecting a composite joint. A light wave is sent through a fiber optic cable running through a cavity of the composite joint, the optic cable extending out from at least one of a first end of the cavity or a second end of the cavity, the fiber optic cable in contact with a composite filler in the cavity. A reflectivity index of the light received from the fiber optic cable is measured. It is determined whether strain has impacted the composite joint based on the reflectivity index.

An embodiment of the present disclosure provides a method of forming a composite joint. A composite filler is placed into a cavity between at least two composite components. A fiber optic cable is placed into the cavity such that the fiber optic cable is in contact with the composite filler. The composite filler and the at least two composite components are resin infused to form the composite joint with integrated strain detector.

Another embodiment of the present disclosure provides a composite joint inspection system. The composite joint inspection system comprises at least two composite components bonded together at a composite joint, a composite filler within the composite joint, and a fiber optic cable embedded between layers of a composite component of the at least two composite components. The fiber optic cable runs along the joint and extends out at least one of a first end of the composite component or a second end of the composite component.

Yet another embodiment of the present disclosure provides a method of inspecting a composite structure. A light wave is sent through a fiber optic cable running through a composite structure, the fiber optic cable extending out from at least one of a first end of the composite structure or a second end of the composite structure, the fiber optic cable in contact with the composite structure. A reflectivity index of the light received from the fiber optic cable is measured. The measured reflectivity index is compared to a baseline reading.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a composite joint inspection system in accordance with an illustrative embodiment;

FIG. 4 is a flowchart of a method of inspecting a composite joint in accordance with an illustrative embodiment;

FIG. 5 is a flowchart of a method of forming a composite joint in accordance with an illustrative embodiment;

FIG. 6 is a flowchart of a method of inspecting a composite structure in accordance with an illustrative embodiment;

FIG. 7 is an illustration of an aircraft manufacturing and service method in a form of a block diagram in accordance with an illustrative embodiment; and

FIG. 8 is an illustration of an aircraft in a form of a block diagram in which an illustrative embodiment may be implemented.

### DETAILED DESCRIPTION

The illustrative examples recognize and take into account one or more considerations. The illustrative examples recognize and take into account that inconsistent results are obtained when inspecting the noodle of integrated structures using conventional non-destructive inspection techniques.

The illustrative examples recognize and take into account that current non-destructive inspection practices include the use of a sweeping ultrasonic probe that is shaped to the same radius as the integrated joint radius. The illustrative examples recognize and take into account that noodles do not have parallel front and back faces. The illustrative examples recognize and take into account that noodles are triangular in cross-section when simplified. The illustrative examples recognize and take into account that due to the non-parallel shape, the reflected and attenuated wave signals are not strongly detected, which can lead to inconsistent results.

The illustrative examples recognize and take into account that there is an access limitation as a physical probe is swept along the regions to be inspected. The illustrative examples recognize and take into account that for conventional ultrasonic inspection, the probe shape is customized to fit the radius of the scanning surface. The illustrative examples recognize and take into account that different probes will be used for different radiuses. The illustrative examples recognize and take into account that multiple probes will be used for swept radius surfaces where the dimension keeps changing. The illustrative examples recognize and take into account that for swept radius surfaces there is no probe shape that is an exact fit.

The illustrative examples recognize and take into account that some composite Noodles use ‘chopped fibers’ which significantly worsen the signal being reflected by the ultrasonic probe. The illustrative examples recognize and take into account that chopped fibers can make ultrasonic inspection incapable of successfully inspecting these new integrated structures.

The illustrative examples recognize and take into account that other non-destructive inspection (NDI) techniques include X-ray CT and acoustic emissions. The illustrative examples recognize and take into account that for X-ray CT, the scanning equipment is expensive and too bulky for the intended area of use for composite noodles. The illustrative examples recognize and take into account that acoustic Emissions (e.g., PZTs) rely on detecting reflected waves. The illustrative examples recognize and take into account that acoustic Emissions (e.g., PZTs) will also be susceptible to poor signal collection for the reasons discussed above.

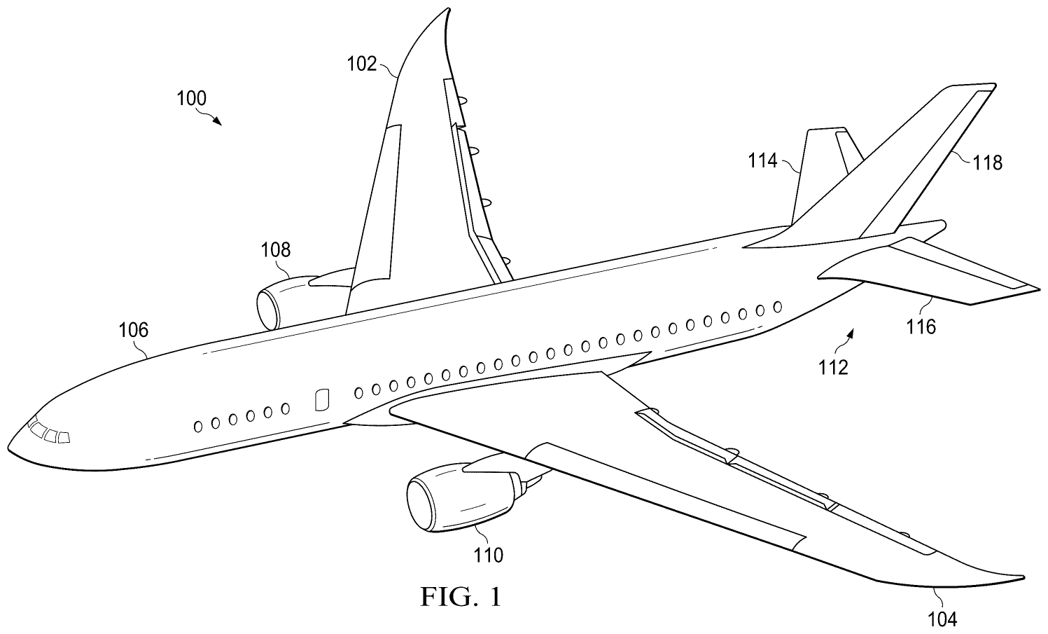

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite joints to be inspected using methods of the illustrative examples. Aircraft 100 is an example of an aircraft that can have composite joints formed using methods of the illustrative examples. Composite joints of the illustrative examples can be present in aircraft 100.

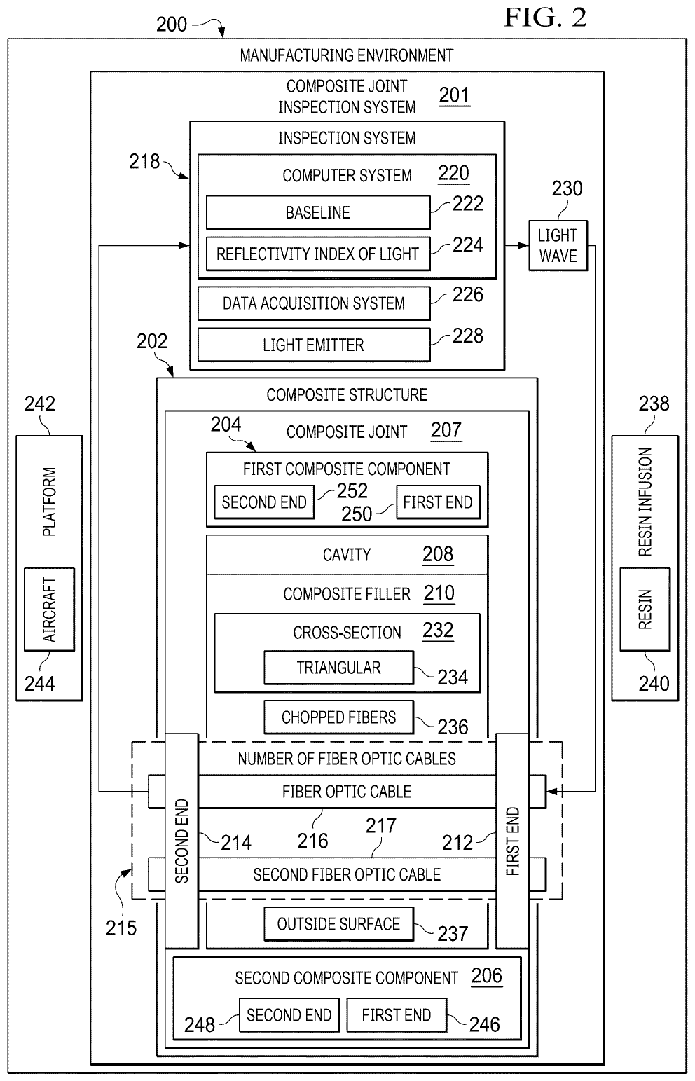

Turning now to FIG. 2, an illustration of a block diagram of a manufacturing environment is depicted in accordance with an illustrative embodiment. Composite joint inspection system 201 can be used in aircraft 100 of FIG. 1. Composite joint inspection system 201 can be formed in manufacturing environment 200. Composite joint inspection system 201 can be utilized outside of manufacturing environment 200 to inspect composite joint 207.

Composite joint 207 is a component of platform 242. Platform 242 can take a number of different forms. For example, platform 242 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a tanker aircraft, a surface ship, a tank, a personnel carrier, a train, a spacecraft, a space station, a satellite, a submarine, an automobile, a power plant, a bridge, a dam, a house, a manufacturing facility, a building, a robot, a robotic arm, a crane, and other suitable types of platforms. In some illustrative examples, platform 242 can be aircraft 244.

Composite joint inspection system 201 comprises cavity 208 formed by at least two composite components, composite filler 210 within cavity 208, and fiber optic cable 216 running through cavity 208 extending out from at least one of first end 212 of cavity 208 or second end 214 of the cavity. Fiber optic cable 216 is in contact with composite filler 210. In this illustrative example, the at least two composite components comprises first composite component 204 and second composite component 206.

In some illustrative examples, fiber optic cable 216 is embedded within composite filler 210. In some of these illustrative examples, composite filler 210 is laid up with fiber optic cable 216 within the layup. In some of these illustrative examples, composite filler 210 is extruded with fiber optic cable 216 within composite filler 210.

In some illustrative examples, fiber optic cable 216 is in contact with one of the at least two composite components and an outside surface of composite filler 210. In some illustrative examples, fiber optic cable 216 is in contact with first composite component 204 and outside surface 237 of composite filler 210. In some illustrative examples, fiber optic cable 216 is in contact with second composite component 206 and outside surface 237 of composite filler 210.

Fiber optic cable 216 is one of number of fiber optic cables 215. Number of fiber optic cables 215 comprises one or more fiber optic cables in contact with composite filler 210. In some illustrative examples, number of fiber optic cables 215 comprises multiple fiber optic cables distributed throughout composite filler 210. In some illustrative examples, number of fiber optic cables 215 comprises more than one fiber optic cable spread out throughout cross section 232 of composite filler 210. Spreading more than one fiber optic cable throughout cross-section 232 of composite filler 210 allows for detecting strain in various cross-sectional locations including the interface between composite filler 210 and at least one of the composite components, first composite component 204 and second composite component 206.

In some illustrative examples, composite joint inspection system 201 comprises second fiber optic cable 217 running through cavity 208 extending out from at least one of first end 212 of cavity 208 or second end 214 of cavity 208. Second fiber optic cable 217 is positioned within composite filler 210.

In this illustrative example, inspection system 218 is connected to fiber optic cable 216 to inspect composite filler 210. In some illustrative examples, inspection system 218 can be temporarily connected to fiber optic cable 216 to inspect composite filler 210 during a set time, such as during manufacturing or maintenance. In some illustrative examples, inspection system 218 can be continuously connected to fiber optic cable 216 to inspect composite filler 210 during operation of platform 242.

Inspection system 218 comprises data acquisition system 226 and light emitter 228. Light emitter is configured to send light wave 230 into fiber optic cable 216. In some illustrative examples, composite joint inspection system 201 further comprises light emitter 228 connected to fiber optic cable 216.

Data acquisition system 226 is configured to receive responses from fiber optic cable 216. Data acquisition system 226 can also be referred to as a detector. In some illustrative examples, composite joint inspection system 201 further comprises data acquisition system 226 connected to the fiber optic cable.

In some illustrative examples, light emitter 228 and the detector can be on the same end of fiber optic cable 216. In some illustrative examples, both light emitter 228 and the detector can be on both ends of fiber optic cable 216. In some illustrative examples of inspection system 218, light from both ends can be emitted so that a location for strain changes can be outputted.

To inspect composite joint 207, light wave 230 is sent through fiber optic cable 216 running through cavity 208 of composite joint 207. In some illustrative examples, fiber optic cable 216 extends out from first end 212 of cavity 208 to second end 214 of cavity 208. Fiber optic cable 216 is in contact with composite filler 210 in cavity 208.

Reflectivity index 224 of the light received from fiber optic cable 216 is measured. In some illustrative examples, it is determined whether strain has impacted composite joint 207 based on reflectivity index 224.

In some illustrative examples, it is determined whether reflectivity index 224 has a change from baseline 222.

In some illustrative examples, reflectivity index 224 and baseline 222 are compared by computer system 220. In some illustrative examples, reflectivity index 224 is analyzed by a joint data analyzer.

In some illustrative examples, a joint data analyzer can be located in computer system 220 and can be implemented in software, hardware, firmware, or a combination thereof. When software is used, the operations performed by the joint data analyzer can be implemented in program instructions configured to run on hardware, such as a processor unit. When firmware is used, the operations performed by the joint data analyzer can be implemented in program instructions and data stored in persistent memory to run on a processor unit. When hardware is employed, the hardware can include circuits that operate to perform the operations in the joint data analyzer.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices.

Computer system 220 is a physical hardware system and includes one or more data processing systems. When more than one data processing system is present in the computer system, those data processing systems are in communication with each other using a communications medium. The communications medium can be a network. The data processing systems can be selected from at least one of a computer, a server computer, a tablet computer, or some other suitable data processing system.

Computer system 220 can include a number of processor units that are capable of executing program instructions implementing processes for the joint data analyzer in the illustrative examples. In other words, the program instructions are computer-readable program instructions.

In some illustrative examples, Brillouin optical time-domain analysis can be utilized to determine whether an inconsistency is present in composite filler 210. Acoustic waves are generated by injecting two counter-propagating light waves, such as light wave 230, with a frequency difference equal to the Brillouin shift. If one of the beams is a short light pulse and its position is determined by time of flight, local variations of strain can be measured along fiber optic cable 216.

In some illustrative examples, composite joint 207 is part of aircraft 244. In some illustrative examples, aircraft 244 comprises composite joint 207 with an integrated strain detector. Composite joint 207 with the integrated strain detector comprises first composite component 204, second composite component 206, and composite filler 210 positioned in cavity 208 between first composite component 204 and second composite component 206. Composite joint further comprises fiber optic cable 216 running through cavity 208 and extending out from at least one of first end 212 of cavity 208 or second end 214 of cavity 208. Fiber optic cable 216 is in contact with composite filler 210.

In some illustrative examples, cross-section 232 of composite filler 210 is triangular 234. Composite joint inspection system 201 provides accurate inspections of composite filler 210 with triangular 234 cross-section 232. Conventional ultrasound inspection techniques are at least one of too difficult, too time-consuming, or inconsistent for inspecting triangular 234 cross-section 232.

In some illustrative examples, composite filler 210 comprises chopped fibers 236. Composite joint inspection system 201 provides accurate inspections of composite filler 210 with chopped fibers 236. Chopped fibers 236 reduce the signal being reflected by the ultrasonic probe, making conventional ultrasonic inspection undesirably difficult or inconsistent to perform on composite filler 210 with chopped fibers 236.

In some illustrative examples, at least one of fiber optic cable 216 or second fiber optic cable 217 can be present in one composite component of composite structure 202. In some illustrative examples, fiber optic cable 216 can be present in first composite component 204. In some illustrative examples, second fiber optic cable 217 can be present in second composite component 206.

In some illustrative examples, composite joint inspection system 201 comprises at least two composite components bonded together at composite joint 207, composite filler 210 within composite joint 207, and fiber optic cable 216 embedded between layers of first composite component 204 of the at least two composite components. Fiber optic cable 216 runs along composite joint 207 and extending out at least one of first end 250 of first composite component 204 or second end 252 of first composite component 204. In some illustrative examples, fiber optic cable 216 is embedded within ten composite plies of composite joint 207.

In some illustrative examples, composite joint inspection system 201 further comprises second fiber optic cable 217 embedded within composite filler 210.

In some illustrative examples, composite joint inspection system 201 further comprises second fiber optic cable 217 embedded between layers of second composite component 206 of the at least two composite components. In these illustrative examples, second fiber optic cable 217 runs along composite joint 207 and extends out at least one of first end 246 of second composite component 206 or second end 248 of second composite component 206.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, number of fiber optic cables 215 comprises more than two fiber optic cables. In some illustrative examples, multiple fiber optic cables can be placed throughout the cross section of cavity 208. In some illustrative examples, adding multiple fiber optic cables can be beneficial for detecting inconsistencies at interfaces between composite filler 210 and composite components of composite structure 202. As another example, cross-section 232 of composite filler 210 is a shape other than generally triangular.

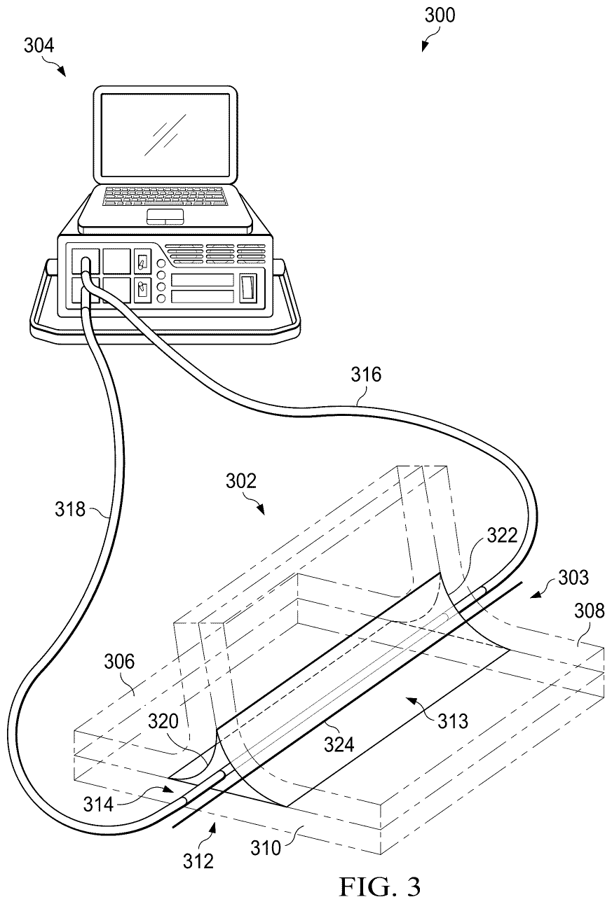

Turning now to FIG. 3, an illustration of a composite joint inspection system is depicted in accordance with an illustrative embodiment. Composite joint inspection system 300 is a physical implementation of composite joint inspection system 201 of FIG. 2.

In this illustrative example, composite structure 302 comprises first composite component 306, second composite component 308, and third composite component 310. Cavity 312 is formed between first composite component 306, second composite component 308, and third composite component 310. Composite filler 313 is present within cavity 312.

Composite joint inspection system 300 comprises cavity 312 formed by at least two composite components, composite filler 313 within cavity 312, and fiber optic cable 314 running through cavity 312 extending out from at least one of first end 320 of cavity 312 or second end 322 of cavity 312. Fiber optic cable 314 is in contact with composite filler 313. In this illustrative example, fiber optic cable 314 is embedded within composite filler 313. In this illustrative example, fiber optic cable 314 is centered within composite filler 313. In some illustrative examples, fiber optic cable 314 is embedded within composite filler 313 at a different location in the cross-section of composite filler 313.

As depicted, composite joint inspection system 300 further comprises second fiber optic cable 324 running through cavity 312 extending out from at least one of first end 320 of cavity 312 or second end 322 of cavity 312. Second fiber optic cable 324 is positioned within composite filler 313.

In this illustrative example, second fiber optic cable 324 is in contact with one of the at least two composite components and an outside surface of composite filler 313. In this illustrative example, second fiber optic cable 324 is in contact with second composite component 308 and an outside surface of composite filler 313.

As depicted, inspection system 304 is connected to fiber optic cable 314. Inspection system 304 is connected to fiber optic cable 314 by connector 316 and connector 318. Inspection system 304 comprises a light emitter and a detector. The detector, or data acquisition system, is configured to receive signals from fiber optic cable 314.

Inspection system 304 sends light waves into fiber optic cable 314. To inspect composite joint 303, a light wave is sent through fiber optic cable 314 running through cavity 312 of composite joint 303. Fiber optic cable 314 extends out from a first end of cavity 312 to a second end of cavity 312. Fiber optic cable 314 is in contact with composite filler 313 in cavity 312.

A reflectivity index of the light received from the fiber optic cable is measured. It is determined whether strain has impacted the composite joint based on the reflectivity index. In some illustrative examples, determining whether strain has impacted the composite joint 303 comprises determining whether the reflectivity index has a change from a baseline. In some illustrative examples, inspection system 304 performs the determination as to whether the reflectivity index has changed from the baseline.

Although fiber optic cable 314 and second fiber optic cable 324 are depicted as within cavity 312, in other illustrative examples at least one fiber optic cable is present in at least one of first composite component 306, second composite component 308, or third composite component 310. In some illustrative examples, a fiber optic cable is present between layers of first composite component 306 along composite joint 303. In some illustrative examples, a fiber optic cable is present between layers of first composite component 306 parallel to cavity 312. In some illustrative examples, a fiber optic cable is present between layers of second composite component 308 along composite joint 303. In some illustrative examples, a fiber optic cable is present between layers of second composite component 308 parallel to cavity 312. In some illustrative examples, a fiber optic cable is present between layers of third composite component 310 along composite joint 303. In some illustrative examples, a fiber optic cable is present between layers of third composite component 310 parallel to cavity 312.

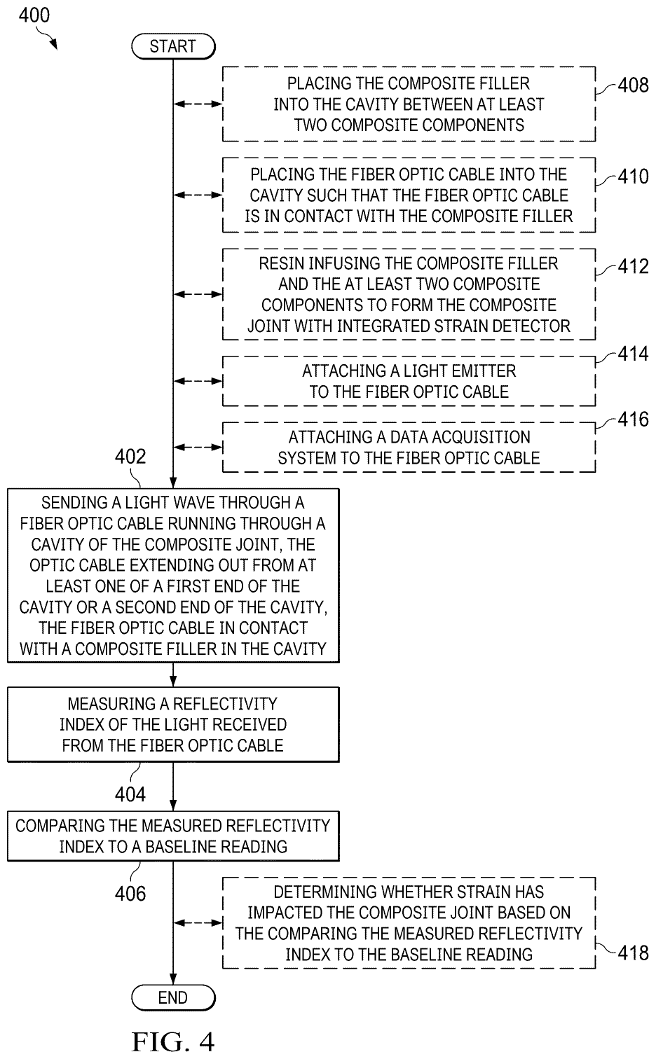

Turning now to FIG. 4, a flowchart of a method of inspecting a composite joint is depicted in accordance with an illustrative embodiment. Method 400 can be used to inspect a composite joint of aircraft 100 of FIG. 1. Method 400 can be used to inspect composite joint 207 of FIG. 2. Method 400 can be performed using composite joint inspection system 201 of FIG. 2. Method 400 can be performed to inspect composite joint 303 of FIG. 3. Method 400 can be performed using composite joint inspection system 300 of FIG. 3.

Method 400 sends a light wave through a fiber optic cable running through a cavity of the composite joint, the optic cable extending out from at least one of a first end of the cavity or a second end of the cavity, the fiber optic cable in contact with a composite filler in the cavity (operation 402). Method 400 measures a reflectivity index of the light received from the fiber optic cable (operation 404). Method 400 compares the measured reflectivity index to a baseline reading (operation 406). Afterwards, method 400 terminates.

In some illustrative examples, method 400 places the composite filler into the cavity between at least two composite components (operation 408). In some illustrative examples, method 400 places the fiber optic cable into the cavity such that the fiber optic cable is in contact with the composite filler (operation 410). In some illustrative examples, the fiber optic cable is placed into the cavity prior to placing the composite filler into the cavity. In some illustrative examples, the fiber optic cable is positioned within the composite filler. In these illustrative examples, placing the composite filler into the cavity simultaneously places the fiber optic cable into the cavity.

In some illustrative examples, method 400 resin infuses the composite filler and the at least two composite components to form the composite joint with integrated strain detector (operation 412). In some illustrative examples, method 400 resin infuses the composite filler while the composite filler is in contact with the fiber optic cable.

In some illustrative examples, method 400 attaches a light emitter to the fiber optic cable (operation 414). In some illustrative examples, method 400 attaches a data acquisition system to the fiber optic cable (operation 416). In some illustrative examples, the light emitter and the data acquisition system are a part of an inspection system connected to the fiber optic cable.

In some illustrative examples, method 400 determines whether strain has impacted the composite joint based on the comparing the measured reflectivity index to the baseline reading (operation 418). In some illustrative examples, the determination is made by an inspection system comprising the data acquisition system and the light emitter. In some other illustrative examples, the reflectivity index is provided to a computer system separate from the inspection system for analysis.

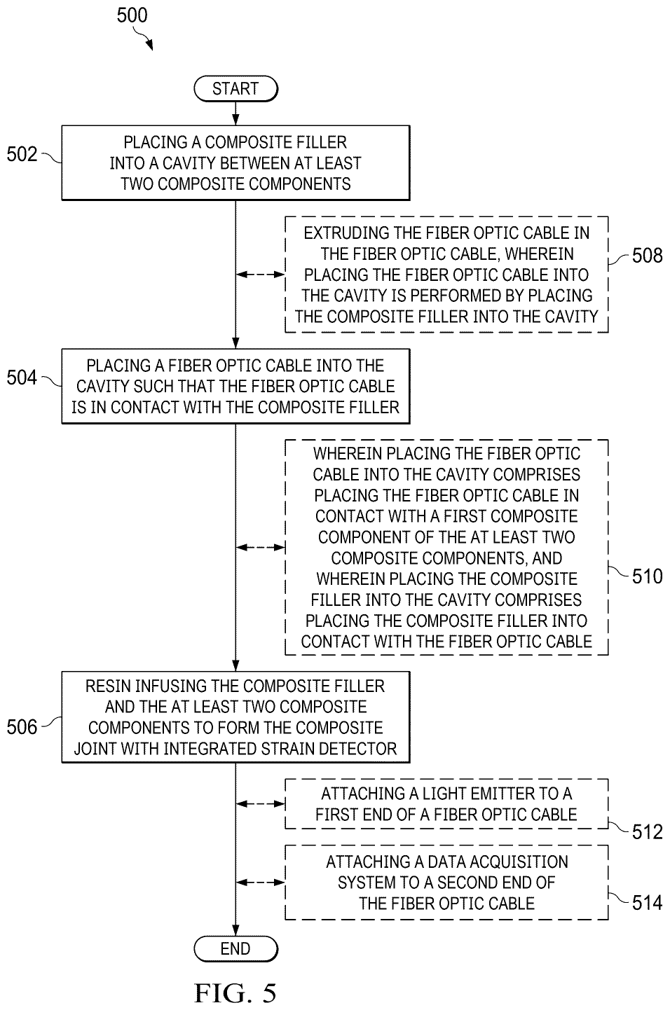

Turning now to FIG. 5, a flowchart of a method of forming a composite joint is depicted in accordance with an illustrative embodiment. Method 500 can be performed to manufacture a component of aircraft 100 of FIG. 1. Method 500 can be performed to manufacture composite joint 207 of FIG. 2. Method 500 can be performed to manufacture composite joint 303 of FIG. 3.

Method 500 places a composite filler into a cavity between at least two composite components (operation 502). Method 500 places a fiber optic cable into the cavity such that the fiber optic cable is in contact with the composite filler (operation 504). Method 500 resin infuses the composite filler and the at least two composite components to form the composite joint with integrated strain detector (operation 506). Afterwards, method 500 terminates.

In some illustrative examples, method 500 extrudes the fiber optic cable in the fiber optic cable, wherein placing the fiber optic cable into the cavity is performed by placing the composite filler into the cavity (operation 508). In some illustrative examples, placing the fiber optic cable into the cavity comprises placing the fiber optic cable in contact with a first composite component of the at least two composite components, and wherein placing the composite filler into the cavity comprises placing the composite filler into contact with the fiber optic cable (operation 510).

In some illustrative examples, method 500 attaches a light emitter to the fiber optic cable (operation 512). In some illustrative examples, method 500 attaches a data acquisition system to the fiber optic cable (operation 514). In some illustrative examples, the light emitter and the data acquisition system are a part of an inspection system connected to the fiber optic cable.

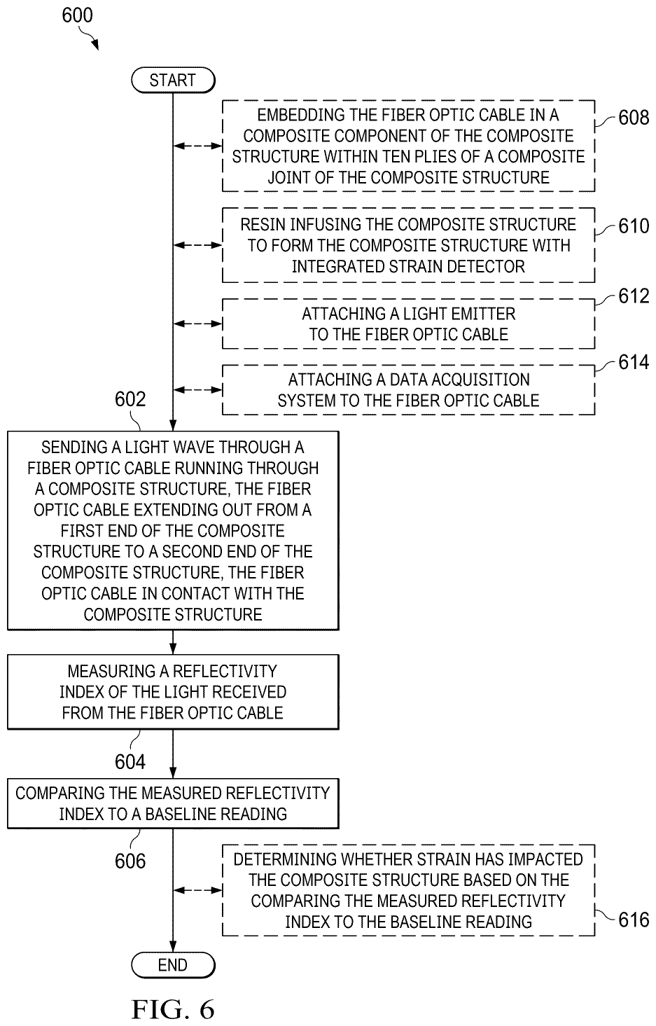

Turning now to FIG. 6, a flowchart of a method of inspecting a composite structure is depicted in accordance with an illustrative embodiment. Method 600 can be used to inspect a composite structure of aircraft 100 of FIG. 1. Method 600 can be used to inspect composite structure 202 of FIG. 2. Method 600 can be performed to inspect composite structure 302 of FIG. 3.

Method 600 sends a light wave through a fiber optic cable running through a composite structure, the fiber optic cable extending out from at least one of a first end of the composite structure or a second end of the composite structure, the fiber optic cable in contact with the composite structure (operation 602). Method 600 measures a reflectivity index of the light received from the fiber optic cable (operation 604). Method 600 compares the measured reflectivity index to a baseline reading (operation 606).

In some illustrative examples, method 600 embeds the fiber optic cable in a composite component of the composite structure within ten plies of a composite joint of the composite structure (operation 608). In some illustrative examples, method 600 resin infuses the composite structure to form the composite structure with integrated strain detector (operation 610).

In some illustrative examples, method 600 attaches a light emitter to the fiber optic cable (operation 612). In some illustrative examples, method 600 attaches a data acquisition system to the fiber optic cable (operation 614).

In some illustrative examples, method 600 determines whether strain has impacted the composite structure based on the comparing the measured reflectivity index to the baseline reading (operation 616). In some illustrative examples, the determination is made by an inspection system comprising the data acquisition system and the light emitter. In some other illustrative examples, the reflectivity index is provided to a computer system separate from the inspection system for analysis.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 408 through operation 418 may be optional. As another example, operation 508 through operation 514 may be optional. As another example, operation 608 through operation 616 may be optional.

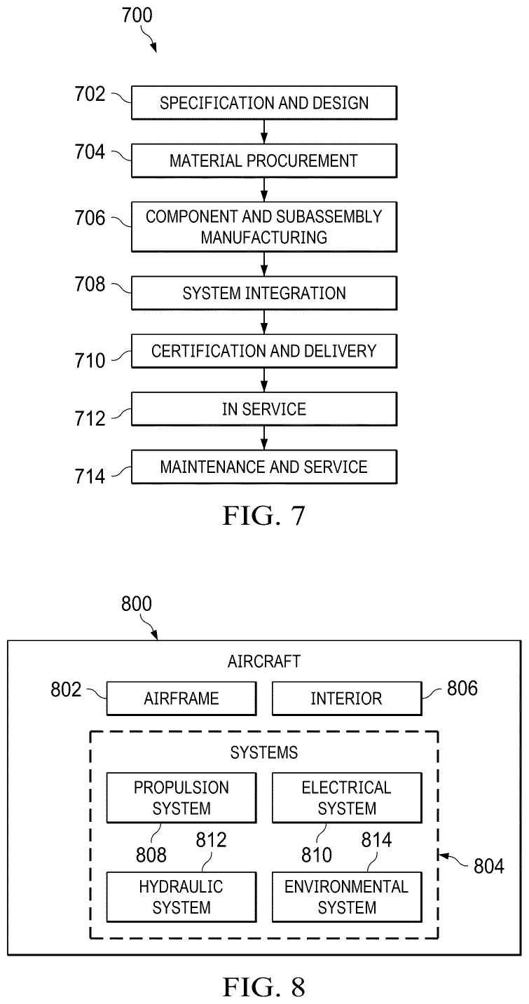

Illustrative embodiments of the present disclosure may be described in the context of aircraft manufacturing and service method 700 as shown in FIG. 7 and aircraft 800 as shown in FIG. 8. Turning first to FIG. 7, an illustration of an aircraft manufacturing and service method in a form of a block diagram is depicted in accordance with an illustrative embodiment. During pre-production, aircraft manufacturing and service method 700 may include specification and design 702 of aircraft 800 in FIG. 8 and material procurement 704.

During production, component and subassembly manufacturing 706 and system integration 708 of aircraft 800 takes place. Thereafter, aircraft 800 may go through certification and delivery 710 in order to be placed in service 712. While in service 712 by a customer, aircraft 800 is scheduled for routine maintenance and service 714, which may include modification, reconfiguration, refurbishment, or other maintenance and service.

Each of the processes of aircraft manufacturing and service method 700 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 8, an illustration of an aircraft in a form of a block diagram is depicted in which an illustrative embodiment may be implemented. In this example, aircraft 800 is produced by aircraft manufacturing and service method 700 of FIG. 7 and may include airframe 802 with plurality of systems 804 and interior 806. Examples of systems 804 include one or more of propulsion system 808, electrical system 810, hydraulic system 812, and environmental system 814. Any number of other systems may be included.

Apparatuses and methods embodied herein may be employed during at least one of the stages of aircraft manufacturing and service method 700. One or more illustrative embodiments may be manufactured or used during at least one of component and subassembly manufacturing 706, system integration 708, in service 712, or maintenance and service 714 of FIG. 7.

The illustrative examples provide an inspection technique that is: a) non-destructive, b) compact, c) easy to install without additional design efforts, d) inexpensive, and e) independent of any wave emitting techniques through the composite material. In the illustrative examples, at least one fiber optic strand is either embedded or bonded along the span of the noodle. Inconsistencies in the noodle can then be determined by a change in the fiber optic cables signal. A change in signal received from the fiber optic cable is associated to inconsistencies or other changes in the noodle.

The illustrative examples provide a different method of detecting inconsistencies in the noodle compared to prior processes. The illustrative examples send a light wave through a fiber optic cable and measure the reflectivity index of light to then determine if there is a change from a ‘baseline’ reading. When a change is detected, the change indicates that the system has been strained and significantly high strain readings/spikes or drops in the signal are an indication that an inconsistency has been created. In the illustrative examples, a fiber optic cable is integrated within the platform structure as a fly-away part as opposed relying solely on scanning equipment on the ground. By avoiding the use of inspection instruments that reflect/refract sonic waves in a non-homogenous material (i.e., the noodle), the inconsistent results can be avoided.

The illustrative examples use lights passing through at least one fiber optic cable for detection of inconsistencies in integrated noodles for resin infused aircraft parts. The illustrative examples detect inconsistencies in the noodle by detecting strain in the embedded fiber optic cable as opposed to directly detecting inconsistencies in the noodle itself. The illustrative examples do not require unique equipment or tools as the geometry of the noodle changes. The illustrative examples are a one-size fits all solution to inspection of composite noodles.

The illustrative examples provide an improved method for inspecting noodles in integrated structures. The illustrative examples can be used as both a passive and active form of inspection in composite joints. The illustrative examples can be used as both a passive and active form of inspection in aircraft structures.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A composite joint inspection system:
a cavity formed by at least two composite components;
a composite filler within the cavity; and
a fiber optic cable running through the cavity extending out from at least one of a first end of the cavity or a second end of the cavity, the fiber optic cable in contact with the composite filler.

2. The composite joint inspection system of claim 1, wherein the fiber optic cable is embedded within the composite filler.

3. The composite joint inspection system of claim 1, wherein the fiber optic cable is in contact with one of the at least two composite components and an outside surface of the composite filler.

4. The composite joint inspection system of claim 1 further comprising:
a second fiber optic cable running through the cavity extending out from at least one of the first end of the cavity or the second end of the cavity, the second fiber optic cable positioned within the composite filler.

5. The composite joint inspection system of claim 1 further comprising:
a light emitter connected to the fiber optic cable.

6. The composite joint inspection system of claim 5 further comprising:
a data acquisition system connected to the fiber optic cable.

7. An aircraft comprising:
a composite joint with an integrated strain detector comprising:
a first composite component;
a second composite component;
a composite filler positioned in a cavity between the first composite component and the second composite component; and
a fiber optic cable running through the cavity extending out from at least one of a first end of the cavity or a second end of the cavity, the fiber optic cable in contact with the composite filler.

8. The aircraft of claim 7, wherein the fiber optic cable is embedded within the composite filler.

9. The aircraft of claim 7, wherein the fiber optic cable is in contact with the first composite component and a surface of the composite filler.

10. The aircraft of claim 7 further comprising:
a second fiber optic cable running through the cavity extending out from at least one of the first end of the cavity or the second end of the cavity, the second fiber optic cable positioned within the composite filler.

11. The aircraft of claim 7 further comprising:
a light emitter connected to a first end of the fiber optic cable.

12. The aircraft of claim 11 further comprising:
a data acquisition system connected to a second end of the fiber optic cable.

13. A method of inspecting a composite joint comprising:
sending a light wave through a fiber optic cable running through a cavity of the composite joint, the fiber optic cable extending out from at least one of a first end of the cavity or a second end of the cavity, the fiber optic cable in contact with a composite filler in the cavity;
measuring a reflectivity index of the light received from the fiber optic cable; and
comparing the measured reflectivity index to a baseline reading.

14. The method of claim 13 further comprising:
determining whether strain has impacted the composite joint based on the comparing the measured reflectivity index to the baseline reading.

15. The method of claim 13 further comprising:
attaching a light emitter to the fiber optic cable; and
attaching a data acquisition system to the fiber optic cable.

16. The method of claim 13 further comprising:
placing the composite filler into the cavity between at least two composite components; and
placing the fiber optic cable into the cavity such that the fiber optic cable is in contact with the composite filler.

17. The method of claim 16 further comprising:
resin infusing the composite filler and the at least two composite components to form the composite joint with integrated strain detector.

18. A method of forming a composite joint comprising:
placing a composite filler into a cavity between at least two composite components;
placing a fiber optic cable into the cavity such that the fiber optic cable is in contact with the composite filler; and
resin infusing the composite filler and the at least two composite components to form the composite joint with integrated strain detector.

19. The method of claim 18 further comprising:
extruding the fiber optic cable in the fiber optic cable, wherein placing the fiber optic cable into the cavity is performed by placing the composite filler into the cavity.

20. The method of claim 18, wherein placing the fiber optic cable into the cavity comprises placing the fiber optic cable in contact with a first composite component of the at least two composite components, and wherein placing the composite filler into the cavity comprises placing the composite filler into contact with the fiber optic cable.

21. The method of claim 18 further comprising:
attaching a light emitter to the fiber optic cable; and
attaching a data acquisition system to the fiber optic cable.

22. A composite joint inspection system:
at least two composite components bonded together at a composite joint;
a composite filler within the composite joint; and
a fiber optic cable embedded between layers of a composite component of the at least two composite components, the fiber optic cable running along the composite joint and extending out at least one of a first end of the composite component or a second end of the composite component.

23. The composite joint inspection system of claim 22 further comprising a second fiber optic cable embedded within the composite filler.

24. The composite joint inspection system of claim 22, wherein the fiber optic cable is embedded within ten composite plies of the composite joint.

25. (canceled)

26. A method of inspecting a composite structure comprising:
sending a light wave through a fiber optic cable running through a composite structure, the fiber optic cable extending out from at least one of a first end of the composite structure or a second end of the composite structure, the fiber optic cable in contact with the composite structure;
measuring a reflectivity index of the light received from the fiber optic cable; and
comparing the measured reflectivity index to a baseline reading. 27-30. (canceled)
